(19) United States
(12) Patent Application Publication
(10) Pub. No.: US 2018/0075933 A1
(43) Pub. Date: Mar. 15, 2018

(54) METHOD AND APPARATUS FOR ONLINE CONDITION MONITORING OF SPENT NUCLEAR FUEL DRY CASK STORAGE SYSTEMS

(71) Applicant: Battelle Energy Alliance, LLC, Idaho Falls, ID (US)

(72) Inventor: Ahmad Y Al Rashdan, Ammon, ID (US)

(21) Appl. No.: 15/703,655

(22) Filed: Sep. 13, 2017

Related U.S. Application Data
(60) Provisional application No. 62/394,058, filed on Sep. 13, 2016.

(51) Int. Cl. G21C 17/06; G21F 5/06; G01T 1/167

(52) U.S. Cl. CPC G21C 17/06; G01M 3/38; G01T 1/167; G21F 5/06

(57) ABSTRACT

A method and apparatus for online condition monitoring of a spent nuclear fuel dry cask storage system. The method comprises monitoring physical parameters of air flowing through inlet vents and outlet vents of a system and observing successive measurements of the parameter for deviations from the baseline to determine if the condition of the system has changed. The parameters may include temperature, pressure, density, mass and volumetric flow rate, nuclear radiation, impurities, humidity, salt content, acidity, chemistry, and fission product gases. The information may then be used directly or to develop an accumulation profile. The data may also be used in modeling or other simulations and to establish condition change signatures. The apparatus includes sensors placed over inlet and outlet vents, sensor interfacing hardware connected to the sensors, and a computer connected to the hardware to acquire, display, and analyze the sensor data and to display the status of the system.

### CROSS-REFERENCE TO RELATED APPLICATIONS

This application claims the benefit of U.S. Provisional Patent Application Ser. No. 62/394,058, filed Sep. 13, 2016, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05ID14517 awarded by the United States Department of Energy. The government has certain rights in the invention.

### TECHNICAL FIELD

The invention, in various embodiments, relates to a method and apparatus for online condition monitoring of spent nuclear fuel dry cask storage systems. More specifically, embodiments of the invention relate to a method and apparatus for continuous ex situ monitoring of spent nuclear fuel in dry cask storage systems by measuring various physical parameters of air flow into and out of the cask system.

### BACKGROUND

Dry cask storage systems are the main alternative for long-term repository of spent nuclear fuel in the United States. Dry cask storage systems rely on non-liquid cooling. The fuel is placed in a canister, which is filled and pressurized with inert gas. The decay heat generated from the fuel is removed by the inert gas, and, through natural circulation, the heat is moved into the canister's internal surface. The heat then dissipates through the canister's medium to its external surface. The canister is typically, though not always, surrounded by a concrete cask, also called a concrete overpack. Air flows into the cask, absorbs the canister's heat, and then flows out of the cask. Air flow is driven by natural convection. Dry cask storage systems differ in their designs, but this functional concept is similar in all systems. In use in the United States since the mid-1980s, dry cask storage systems have been receiving increasing attention. The termination of the Yucca Mountain geologic repository program accelerated the need for utilities to rely on dry cask storage systems for long-term storage. Therefore, a continuously increasing use of dry cask storage systems is expected in the United States.

The safety and security of dry cask storage systems are achieved through intensive simulation, surveillance, and periodic manual inspections. Simulations can predict the behavior of important phenomena in the systems. However, simulations are associated with uncertainties, especially because of the lack of information on the dry cask storage system's actual internal environment. Manual inspections detect limited types of abnormalities and do not facilitate a prompt warning and response. Deployed means to online monitor dry cask storage systems are limited to basic pressure, temperature, or radiation sensors to generate an overall alarm for abnormalities. However, this type of monitoring is not sufficient or comprehensive.

Instrumentation for dry cask storage systems can be categorized into in situ and ex situ techniques. In situ instruments are placed inside the concrete cask but inside or outside the canister. Ex situ instruments are placed on the exterior surface of the concrete cask or around it. In situ efforts have several limitations that hinder their near-term deployment. Some of these limitations are the narrowness of the space between the canister and the concrete cask, which constrains the size of in situ instruments and their supporting structures; the lack of direct access to the narrow space, which hinders the installation and wiring of the instruments; the harsh environment of the narrow space, such as high radiation, temperature and air speed, which necessitates very robust and tolerant instruments; and the localized nature of placement of in situ instruments on the canister surface, which provides location-specific information only and can degrade the canister performance at that location. Despite these limitations, in situ instrumentation has been explored. For example, contact temperature instruments using Johnson noise thermometry and ultrasonic temperature probe and a non-contact temperature instrument using passive millimeter-wave radiometry in a dry cask storage system environment have been evaluated. The use of an eddy current array probe for surface inspection also has been investigated.

Current ex situ efforts provide limited information on the status of the dry cask storage system, and the information is biased towards the measurement position. However, ex situ instruments are more suitable for near-term deployment. U.S. Pat. No. 8,013,744 to Tsai discloses a radio frequency identification surveillance tag that may be applied in security-based monitoring of spent nuclear fuel by monitoring the seal, temperature, humidity, location, shock, and radiation at the surface of a spent nuclear fuel drum. The device can also be attached to a certain location of a concrete cask. However, because of the size of a concrete cask, this device will give an indication that is biased towards the installation position. U.S. Pat. No. 9,520,057 to Tsai discloses a system for monitoring environmental parameters of critical facilities. This system is another dry cask storage system ex situ monitoring device that is focused towards the safety aspects of dry cask storage systems. Both of these devices provide position-dependent and basic detection of abnormalities. U.S. Pat. No. 7,514,695 to Caffrey discloses a detector and method for inspecting a sealed nuclear storage container, which succeeded in detecting the location of missing fuel assemblies in a dry cask storage system through gamma scanning of the top surface.

### BRIEF SUMMARY

An embodiment of the invention relates to a method of monitoring a dry cask storage system that includes the steps of monitoring air flowing into and out of the concrete cask through its vents by observing measurements of one or more physical parameters of the air, establishing baselines for these parameters, and monitoring the successive measurements of these parameters for deviations compared to the baselines. The deviations may be used to determine whether the condition of the dry cask storage system has changed. These parameters include temperature, pressure, density, mass and volumetric flow rates, nuclear radiation, impurities, humidity, salt content, acidity, chemistry, fission product gases, concentrations and properties of sand, debris, dust, impurities, gases, and combinations thereof. In certain embodiments of the invention, the air flowing into and out of the concrete cask may be monitored at one inlet vent and one outlet vent, at more than one inlet vent and at more than one outlet vent, at a plurality of the inlet and the outlet vents, at the majority of the inlet and outlet vents, or at all inlet vents and at all outlet vents.

In further embodiments of the invention, baseline and successive measurements may be input into one or more simulation models. The baseline and the successive measurements may be used as boundary conditions for the simulation model, and patterns may be identified from the baseline, successive measurements, simulation model results, and conservation equations to establish a condition change signature to associate specifically to a cause of the condition change. The difference between the baseline and the successive measurements may be compared to individual uncertainties and combined uncertainties of the baseline and to individual uncertainties and combined uncertainties of the successive measurements.

Another embodiment of the invention further includes establishing a baseline of the historical measurements of the physical parameter.

Another embodiment of the invention further includes establishing a baseline of the difference between the physical parameter at the inlet vents monitored and the physical parameter at the outlet vents monitored over time and integrating the difference to establish an accumulated difference baseline of the physical parameter, and comparing the difference to the individual or combined measurement uncertainties.

Another embodiment of the invention further includes establishing a baseline from correlating at least two physical parameters at the inlet vents monitored and at the outlet vents monitored.

Another embodiment of the invention further includes establishing a baseline of the historical measurements of the physical parameter for an array of dry cask storage systems and monitoring successive measurements of the physical parameter of at least one dry cask storage system in the array for deviations from the baseline for the array.

Another embodiment of the invention further includes observing measurements of one or more physical parameters at least two inlet vents to establish a baseline for the parameter at each of the inlet vents monitored and monitoring successive measurements of the parameter for the monitored inlet vents for deviations compared with the baseline.

Another embodiment of the invention further includes observing measurements of one or more physical parameters at least two outlet vents to establish a baseline for the parameter at each of the outlet vents monitored and monitoring successive measurements of the parameter for the monitored outlet vents for deviations compared with the baseline.

Another embodiment of the invention includes an apparatus for online monitoring a dry cask storage system that includes at least one sensor configured to be placed over at least one inlet vent and at least one outlet vent of a dry cask storage system for monitoring at least one physical parameter of air flow at the vents. Hardware is wired or wirelessly connected to the sensors for interfacing with the sensors, and a computer is wired or wirelessly connected to the sensor interfacing hardware. The computer may be used, for example, to acquire and display physical parameter data, to display the status of the dry cask storage system, to display condition alerts, to establish baselines for the physical parameter data, condition change signatures, and physical parameter profiles, and to compare successive measurements to baselines.

### BRIEF DESCRIPTION OF THE DRAWINGS

FIG. 1 is a simplified depiction of a spent nuclear fuel dry cask storage system, its inlet and outlet vents, and detector placement for ongoing monitoring of the dry cask;

FIG. 2 is a simplified depiction of a sensor, its connection, which may be wired or wireless, to hardware for interfacing with the sensor, and its connection, which may be wired or wireless, to a computer to acquire and display the sensor information;

FIG. 3 is a depiction of the application of the control volume approach to monitoring the dry cask;

FIG. 4 is an example of a plot illustrating the observation of heat dissipation abnormality from observing the baseline; and

FIG. 5 is an example of a plot of accumulated impurities buildup measurement.

### DETAILED DESCRIPTION

In an ex situ concept, sensors are placed over inlet and outlet vents of a spent nuclear fuel dry cask storage system to online monitor the performance of the dry cask storage system through a control volume approach. The sensors measure a variety of physical parameters for the air flow entering and exiting the dry cask storage system. The measurements allow several in situ performance characteristics of the dry cask storage system to be revealed. The measurements are used directly as well as in models and simulations to determine whether conditions in the dry cask storage system have changed and the cause of the changes. A condition change signature can be established to associate specifically to a cause of a condition change so that response actions can be taken immediately rather than waiting to analyze the measurements, determine the cause, then taking action. This method and apparatus allows these performance characteristics to be monitored continuously while not interfering with the functionality of the dry cask storage system. Thus, a method and apparatus for online condition monitoring of spent nuclear fuel dry cask storage systems are disclosed.

The following description provides specific details to provide a thorough description of embodiments of the invention. However, a person of ordinary skill in the art will understand that the embodiments of the invention may be practiced without using these specific details. Indeed, the embodiments of the invention may be practiced in conjunction with conventional systems and methods used in the industry. In addition, only those components and acts necessary to understand the embodiments of the invention are described in detail. A person of ordinary skill in the art will understand that some components may not be described herein but that using various conventional components and acts would be in accord with the disclosure. Any drawings accompanying the present application are for illustrative purposes only and are not necessarily drawn to scale. Elements common among figures may retain the same numerical designation.

As used herein, the term spent nuclear fuel dry cask storage system means and includes a canister for containing the spent nuclear fuel and inert gas and a storage cask or storage bunker that surrounds the canister.

As used herein, the term over in reference to the placement of a sensor means and includes placement of a sensor or more than one sensor over, adjacent to, above, in close proximity to, next to, or otherwise configured in a position related to a vent or vents of a dry cask storage system to allow the sensor to measure one or more physical parameters of the air flow.

As used herein, the term conservation equations means and includes equations for conservation of mass, conservation of energy, and conservation of momentum.

As used herein, the term impurities means and includes substances, components, and constituents that are not normally contained in air, or substances, components, and constituents that are present in an amount or concentration outside of their normal range in air. Impurities may include, for example, sand, iron ions, very small debris, dust, etc.

As used herein, the term chemistry means and includes the composition, constituent concentrations, and properties, etc., of the air flow.

As used herein, the term configured refers to a size, shape, material composition, and arrangement of one or more of at least one structure and at least one apparatus facilitating operation of one or more of the structure and the apparatus in a pre-determined way.

As used herein, the term substantially in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term about in reference to a given parameter is inclusive of the stated value and has the meaning dictated by the context (e.g., it includes the degree of error associated with measurement of the given parameter).

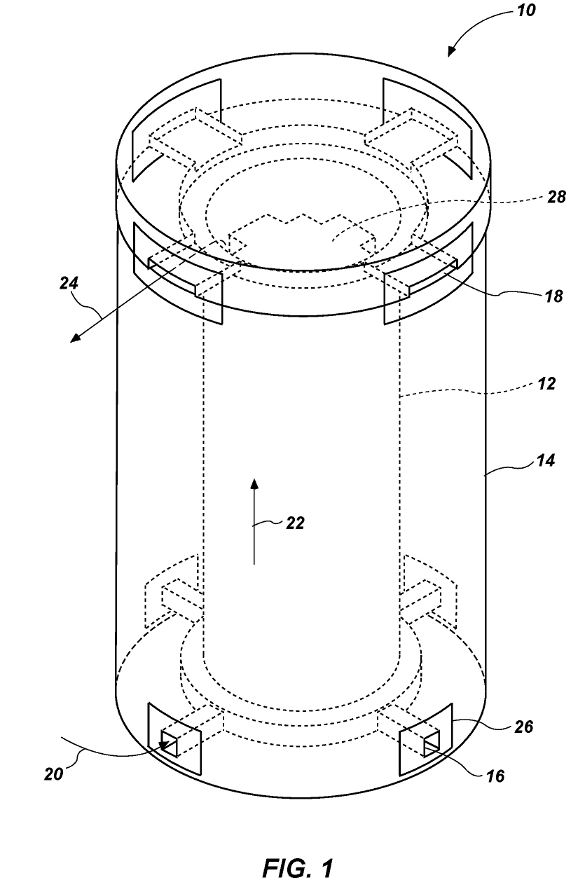

FIG. 1 is a simplified depiction of a spent nuclear fuel dry cask storage system, indicated generally by numeral 10. The storage system includes a canister 12, which would contain the spent nuclear fuel, 28, and inert gas. The canister 12 is surrounded by a storage cask 14, which is typically made of concrete. The storage cask 14 has inlet vents 16 and outlet vents 18. The number of vents may vary depending on the design of the dry cask storage system. Air flows into the inlet vents 16 as shown by arrow 20, through the storage cask 14 as shown by arrow 22, and out of the outlet vents 18 as shown by arrow 24. Sensors 26 are placed over one, more than one, a plurality of, a majority of, or all inlet vents 16 and over one, more than one, a plurality of, a majority of, or all outlet vents 18. Any number and combination of sensors can be used to measure various physical parameters of the air.

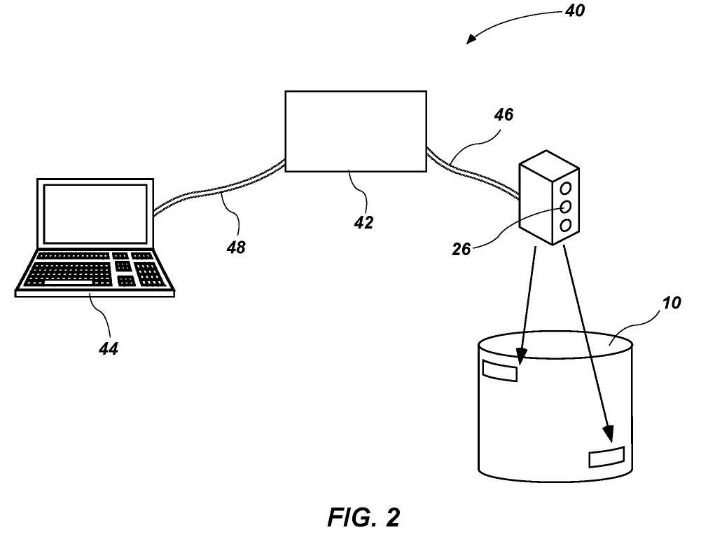

FIG. 2, indicated generally by numeral 40, is a simplified depiction of a monitoring system used for a dry cask storage system 10. The system includes the sensor's 26 connection to hardware 42 for interfacing with the sensor 26, and the hardware's connection to a computer 44 to acquire and display the sensor information to be used for purposes including displaying the status of the dry cask storage system 10 and establishing baselines for physical parameters. The connection 46 between sensor 26 and hardware 42 and the connection 48 between hardware 42 and computer 44 may be wired or wireless connections.

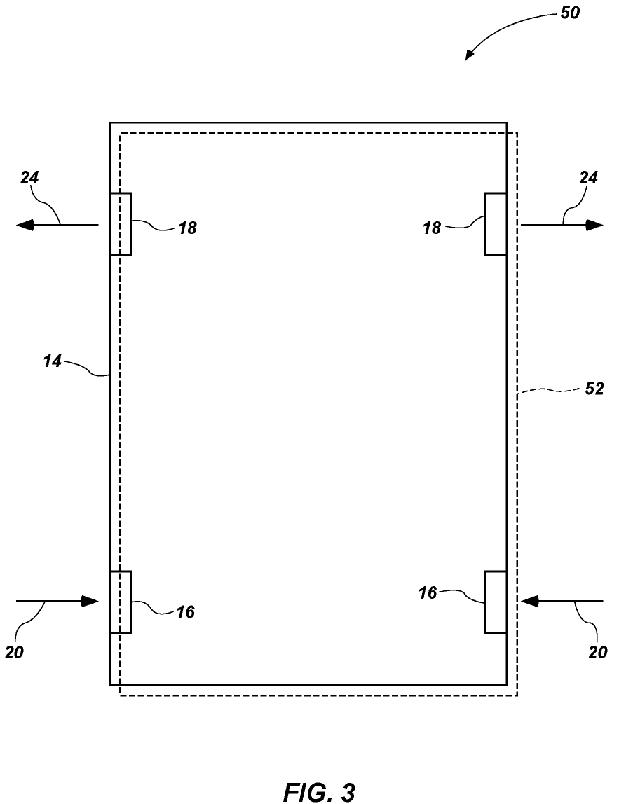

The present invention is directed towards a method and apparatus for online condition monitoring of spent nuclear fuel dry cask storage systems that applies a control volume approach as depicted in FIG. 3, indicated generally by numeral 50. The control volume 52 overlays the storage cask 14, and applies to the air flowing in (arrows 20) through the inlet vents 16 and air flowing out (arrows 24) through the outlet vents 18 of a storage cask 14. The control volume approach in FIG. 3 and the present invention applies to various vented dry cask storage system designs, including vertical dry cask storage systems and horizontal dry cask storage systems.

To apply the control volume 52 (FIG. 3), air flowing in and out of a dry cask is continuously monitored by the sensors, which capture the physical parameters of the air. Other designs of the device can be a frame-like structure surrounding the vent at one, two, three, or four sides. Each device is equipped with sensors for air characteristics measurement including temperature, pressure, density, mass and volumetric flow rates, nuclear radiation, impurities, humidity, salt content, acidity, chemistry, fission product gases, and combinations thereof. A variety of sensors can be used to achieve the required measurements. For example, the sensors could incorporate laser lines, ultrasonic waves, or a combination of both. A high-resolution optical or infrared image acquisition system can be used. As illustrated in the monitoring system 50 in FIG. 2, the acquired measurements are sent through a wire or wireless connection 46 to interfacing hardware 42 and through a wire or wireless connection 48 to a computer 44, where the measurements are interpreted.

Sensors can be placed over one, more than one, a plurality of, a majority of, or all inlet vents and over one, more than one, a plurality of, a majority of, or all outlet vents to monitor the air flowing in and out of a dry cask. For a particular dry cask storage system, sensors may be placed over all inlet vents and outlet vents and measurements obtained for simulation modeling. Then, based on the results of the modeling, placing sensors on a plurality of the inlet vents and a plurality of the outlet vents may be determined to provide acceptable online condition monitoring data.

The present invention allows online condition monitoring and using the acquired measurements to establish a variety of baselines for use in different analyses. The baselines can then be used in additional analyses, including as boundary conditions for simulation models and to establish condition change signatures.

An embodiment of the invention relates to a method of monitoring a dry cask storage system that includes the steps of monitoring air flowing into and out of the concrete cask through its vents by monitoring one or more physical parameters of the air, establishing baselines for these parameters, and observing successive measurements for deviations from the baseline to determine whether the condition of the dry cask storage system has changed. These parameters include temperature, pressure, density, mass and volumetric flow rates, nuclear radiation, impurities, humidity, salt content, acidity, chemistry, fission product gases, and combinations thereof. The air flowing into and out of the concrete cask may be monitored at one inlet vent and one outlet vent, at more than one inlet vent and at more than one outlet vent, at a plurality of inlet and outlet vents, at the majority of inlet and outlet vents, or at all inlet vents and at all outlet vents.

Another embodiment of the invention relates to a method of monitoring a dry cask storage system that further includes establishing a baseline of the historical measurements of the physical parameter, inputting the historical baseline and successive measurements into a simulation model, using the historical baseline and successive measurements as boundary conditions for the simulation model, and identifying patterns from the historical baseline, successive measurements, simulation model results, and conservation equations to establish a condition change signature to associate specifically to a cause of the condition change. For example, if the parameters monitored in the dry cask storage system exhibited certain measurement values at an earlier time (for instance, one month prior) under environmental conditions similar to the present time period being monitored, then the baseline established for the earlier time period can be used to analyze the successive measurements for those parameters. Therefore, successive measurements that are different from the baseline could indicate a change in the condition of the dry cask storage system itself.

Another embodiment of the invention relates to a method of monitoring a dry cask storage system that further includes establishing a baseline of the difference between the physical parameter at the inlet vents monitored and the physical parameter at the outlet vents monitored over time, integrating the difference to establish an accumulated difference baseline of the physical parameter, comparing the difference to the individual or combined measurement uncertainties, inputting the accumulated difference baseline into a simulation model, using the accumulated difference baseline as a boundary condition for the simulation model, and identifying patterns from the accumulated difference baseline, successive measurements, simulation model results, and conservation equations to establish a condition change signature to associate specifically to a cause of the condition change. The physical parameters in this embodiment further include concentrations and properties of sand, debris, dust, impurities, gases, and combinations thereof.

An accumulative approach of measurements can be used in the application of the control volume approach to monitoring the dry cask. Using an accumulative approach, performance will not necessarily be evaluated at a certain point of time only but can be based on the successive and historical acquired measurements. Measuring the characteristics of air including temperature, pressure, density, mass and volumetric flow rate, nuclear radiation, impurities, salt content, acidity, chemistry, fission product gases, and combinations thereof can be used to predict several performance characteristics of the dry cask. These characteristics include the overall amount of heat being dissipated from the spent nuclear fuel, the integrity of the spent nuclear fuel, the amount of dust and debris accumulated on the canister's surface, the amount of corrosion occurring on the canister's surface, the occurrence of canister leakage, the occurrence of abnormalities with the fuel geometry and heat dissipation, the presence of flow obstacles at any point of the flow path, the level of degradation of the overpack, and the occurrence of overpack leakage. Some of these measurements can be directly reflected into performance indicators. Others need to be coupled with simulation tools or physical models.

Another embodiment of the invention relates to a method of monitoring a dry cask storage system that further includes establishing a baseline of the historical measurements of the physical parameter for an array of dry cask storage systems, comparing the successive measurements of the physical parameter of at least one dry cask storage system in the array to the baseline for the array, inputting the historical baseline and successive measurements of the array into a simulation model, using the baseline and successive measurements as boundary conditions for the simulation model, and identifying patterns from the historical baseline and successive measurements for the array, simulation model results, and conservation equations to establish a condition change signature to associate specifically to a cause of the condition change. Dry cask storage systems are usually placed in an array of dry cask storage systems rather than just an individual storage system. Therefore, the baseline behavior of the array of storage systems can be used to compare to behaviors of a single storage system within the array.

Another embodiment of the invention relates to a method of monitoring a dry cask storage system that further includes establishing a baseline from correlating at least two physical parameters at the inlet vents monitored and at the outlet vents monitored, inputting correlated baseline and successive measurements into a simulation model, using baseline and successive measurements as boundary conditions for the simulation model, and identifying patterns from the correlated baseline, successive measurements, simulation model results, and conservation equations to establish a condition change signature to associate specifically to a cause of the condition change.

Another embodiment of the invention relates to a method of monitoring a dry cask storage system that includes the steps of monitoring air flowing into and out of the vents of the concrete cask by monitoring one or more physical parameters of the air, establishing baselines for each of the vents monitored for these parameters, observing successive measurements of the physical parameter of at least one inlet vent monitored for deviations from the baselines of the other inlet vents monitored to determine if the condition of the dry cask storage system has changed, and observing successive measurements of the physical parameter of at least one outlet vent monitored for deviations from the baselines of the other outlet vents monitored to determine if the condition of the dry cask storage system has changed. These parameters include temperature, pressure, density, mass and volumetric flow rates, nuclear radiation, impurities, humidity, salt content, acidity, chemistry, fission product gases, and combinations thereof. The air flowing into and out of the concrete cask may be monitored at more than one inlet vent and at more than one outlet vent, at a plurality of inlet and outlet vents, at a majority of inlet and outlet vents, or at all inlet vents and at all outlet vents.

Another embodiment of the invention further includes monitoring measurements of one or more physical parameters at least two inlet vents to establish a baseline for the parameter at each of the inlet vents monitored and observing successive measurements of the parameter for the monitored inlet vents for deviations compared with the baseline. Another embodiment of the invention further includes monitoring measurements of one or more physical parameters at least two outlet vents to establish a baseline for the parameter at each of the outlet vents monitored and observing successive measurements of the parameter for the monitored outlet vents for deviations compared with the baseline. These embodiments may further include inputting the baseline and successive measurements into a simulation model, using the baseline and successive measurements as boundary conditions for the simulation model, and identifying patterns from the historical baseline, successive measurements, simulation model results, and conservation equations to establish a condition change signature to associate specifically to a cause of the condition change.

Another embodiment of the invention includes an apparatus for online monitoring a dry cask storage system that includes at least one sensor placed over at least one inlet vent and at least one outlet vent of a dry cask storage system for monitoring at least one physical parameter of air flow at the vents. Hardware is wired or wirelessly connected to the sensors for interfacing with the sensors, and a computer is wired or wirelessly connected to the sensor interfacing hardware to acquire, analyze, and display the physical parameter data produced by the sensor, to display the status of the dry cask storage system, to establish baselines for the physical parameter data, and to compare successive measurements to baselines.

### EXAMPLES

### Example 1

Since the device measures the flow rate, temperature and air composition in and out of the dry cask, the steady state dissipated heat into air can be determined using:

Q=Σᵢ₌₁^{i=N}^{ₒᵤₜ}m_{i,out}T_{i,out}C_{i,p,out}−Σᵢ₌₁^{i=N}^{ᵢₙ}m_{i,in}T_{i,in}C_{i,p,in}−EE−DE+OE (1)

where Q is the dissipated heat rate, Nₒᵤₜ is the number of outlet vents, Nᵢₙ is the number of inlet vents, mᵢ is the mass flow rate at vent i, Cₚ is the specific heat capacity, T is the temperature, FE is the rate of escaped energy through the overpack surface and ground, DE is the rate of energy that is absorbed and stored, and OE is the rate of other sources of energy including radiation and chemical interactions. Most of the heat will be transferred to the flowing air. A small portion will be transferred through the overpack. A very small portion will be transferred back into the dry cask, and a negligible amount of heat is lost or generated through chemical and radiation interactions. After years in spent fuel pools, the decay heat profile is expected to be very steady. Any changes to the heat profile can be interpreted as a performance change of the dry cask.

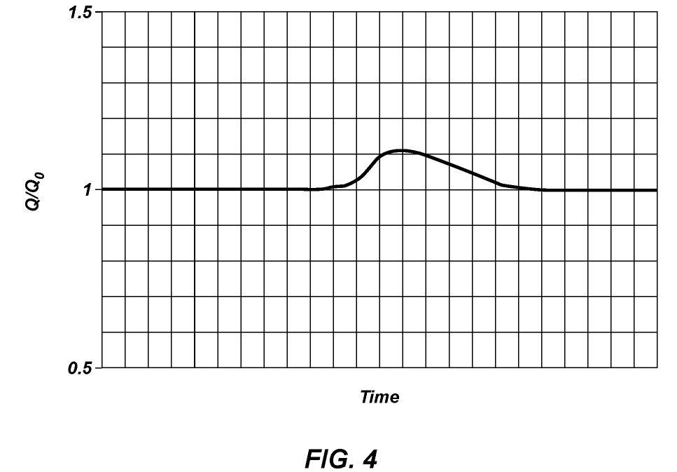

For example, a single, sudden and significant increase of Q, as shown FIG. 4, is associated typically with fuel relocation. The peak of FIG. 4 results from the dissipation of internal fuel energy into the canister surface as they come in direct contact. Once the fuel is in equilibrium with the canister, the heat dissipation rate returns to the initial rate. A slow increase of heat dissipation slope can indicate several types of failure. If the effect is observed alone without an increase of radiation or flow rate, it could indicate an overpack's concrete degradation (EE is reducing). A slow increasing difference of heat dissipation from one radial location to another indicates local degradation of the canister or overpack performance (depending of the degree of difference). This observation can be correlated with the impurities or salt accumulation to determine the cause of the degradation.

### Example 2

Since the device measures the flow rate and characteristics of air flowing in and out of a canister, the net flow rate of air can be determined as:

F=Σᵢ₌₁^{i=N}^{ₒᵤₜ}(m_{i,out}−d_{i,out}−e_{i,out})−Σᵢ₌₁^{i=N}^{ᵢₙ}(m_{i,in}−d_{i,in}−e_{i,in}) (2)

where dᵢ is the solid impurities concentration in air, and eᵢ is the concentration of other elements in air. The net flow rate of air can be used for several performance indicators. For instance, a steady increase of the net air flow indicates that an additional source of flow has been introduced, possibly a canister helium leak or overpack leak. This measurement can be correlated with other measurements to determine the cause. A steady accumulated negative net flow rate indicates an overpack leak. A sudden reduction of the flow rate in multiple vents could indicate that an obstacle blocked the flow path.

### Example 3

The radiation level measurement at each vent can be interpreted by itself or correlated with other measurements for a performance indication. For example, an increase of the ratios of radiation level and heat dissipation in one vent to other vents points towards the radial location of a canister leakage. An increase of radiation level at an outlet and inlet vent indicates an external source of radiation (e.g., failure of an adjacent dry cask). An increase of radiation at the inlet vents only indicates fuel relocation.

### Example 4

Because of the nature of dry casks storage facilities, air flowing through the dry cask will contain several types of solid impurities (e.g., sand, iron ions, very small debris and dust). Despite the presence of several instruments with high measurement sensitivity, a single measurement comparison of the inlet and outlet impurities would not result in a meaningful offset. In these cases, an accumulative approach can be used. The amount of accumulated impurities can be found using:

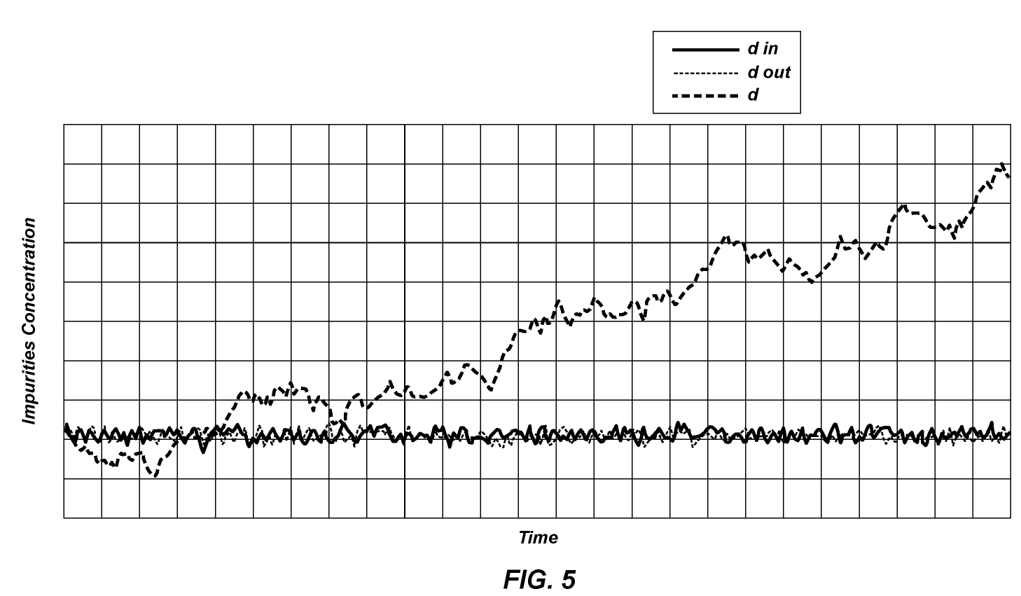

d=Σᵢ₌₁^{i=N}^{_{N}}∫d_{i,in}dt−Σᵢ₌₁^{i=N}^{ₒᵤₜ}∫d_{i,out}dt (3)

Where d is the accumulated impurities buildup. The behavior of d_{i,in}, d_{i,out} and d will produce a pattern similar to FIG. 5. While the inlet and outlet readings are very unstable, and thus provide meaningless data for any point of time, the accumulated impurities do have a meaningful value. If the amount of accumulated impurities in a dry cask is known, a simulation such as Monte Carlo of the dry cask can provide the geometrical deposition profile of impurities inside the dry cask.

### Example 5

The salt, gases, and humidity concentrations of air can be accumulated in a similar manner to impurities. These data, along with other characteristics, such as the temperature profile of the canister, can be input into a simulation tool or a model to develop a corrosion profile of the canister.

### Example 6

An unauthorized access to the dry cask will trigger significant changes of various measurements. For instance, sabotage activity by intentionally blocking air vents will be detected by measurements such as flow rate drop in multiple vents, outlet temperature increase, impurities drop, and salt and humidity changes. Unauthorized access into the dry cask by overpack breach will be detected by measurements such as flow rate drop in multiple vents, heat drop, impurities drop, and salt and humidity changes. The removal of a fuel assembly from the canister will be detected by a heat dissipation drop and radiation drop.

### Example 7

For an extremely small leak in the canister, the concentration of helium at an outlet vent will start to deviate gradually from the normal baseline. The increase of helium concentration can be detected by comparing its measurement at the vent above the leakage location to other vents in the dry cask. The significance of the detected deviation will depend on the uncertainties of the measurements. As a result, a mean measurement has significantly deviated from the normal baseline when the deviation indicator, Dₘ, is large, where Dₘ is:

$${D}_{m} = \sum \frac{{μ}_{m} - {μ}_{b }}{{σ}_{m} + {σ}_{b}} \qquad ( 4 )$$

μₘ is the mean measurement of the physical parameter at an inlet or outlet, σₘ is the uncertainty of the physical parameter mean at an inlet or outlet, μ_{b} is the mean of the normal baseline of the physical parameter at an inlet or outlet, σ_{b} is the uncertainty of the mean of the normal baseline of the physical parameter at an inlet or outlet. The decision making process to confirm the conclusion that an abnormality has occurred and identify the type of abnormality can use an approach that associates weights (wₘ), reflecting importance, to every physical parameter deviation (Dₘ) from multiple baselines. For canister leakage, the detection of increasing helium concentration at an outlet will have higher weight than the increase of outlet flow temperature. Classification methods such as forest trees, random forest trees, or clustering methods can also be used to reach the conclusion of an abnormality. Canister leakage will include multiple events of the tree that occur at a certain sequence to reach the decision end of the tree.

The invention claimed is:

1. A method for online condition monitoring of a dry cask storage system comprising:
observing a measurement of a physical parameter of air flow at least one inlet vent of the dry cask storage system to establish at least one baseline for the at least one inlet vent for the parameter;
observing the measurement of the physical parameter of air flow at least one outlet vent of the dry cask storage system to establish at least one baseline for the at least one outlet vent for the parameter;
monitoring successive measurements of the physical parameter for the at least one inlet vent and the physical parameter for the at least one outlet vent; and
comparing the successive measurements to the baseline.

2. The online condition monitoring method of claim 1, wherein the physical parameter is selected from the group consisting of temperature, pressure, density, mass and volumetric flow rate, nuclear radiation, impurities, humidity, salt content, acidity, chemistry, fission product gases, and combinations thereof.

3. The online condition monitoring method of claim 1, further comprising inputting the baseline and the successive measurements into a simulation model and using the baseline and the successive measurements as boundary conditions for the simulation model.

4. The online condition monitoring method of claim 3, further comprising identifying patterns from the baseline, the successive measurements, simulation model results, and conservation equations to establish a condition change signature to associate specifically to a cause of the condition change.

5. The online condition monitoring method of claim 4, wherein a difference between the baseline and the successive measurements is compared to individual uncertainties and combined uncertainties of the baseline and the individual and combined uncertainties of successive measurements.

6. The online condition monitoring method of claim 5, wherein the baseline further comprises historical measurements of the physical parameter at the at least one inlet vent and at the at least one outlet vent.

7. The online condition monitoring method of claim 5, wherein the baseline further comprises a difference between the measurements of the physical parameter at the at least one inlet vent and the measurements of the physical parameter at the at least one outlet vent over time, and the difference is integrated to establish an accumulated difference baseline of the physical parameter.

8. The online condition monitoring method of claim 5, wherein the baseline further comprises a correlation of the measurements of at least two physical parameters at the at least one inlet vent and at the at least one outlet vent.

9. The online condition monitoring method of claim 5, wherein the dry cask storage system is one system in an array of dry cask storage systems, and further comprises observing the measurement of the physical parameter of air flow at least one inlet vent and at least one outlet vent of at least two dry cask storage systems in the array to establish the at least one baseline for the parameter at each of the at least two dry cask storage systems in the array, monitoring the successive measurements of the parameter at each of the at least two dry cask storage systems in the array, and comparing the successive measurements to the baseline.

10. The online condition monitoring method of claim 9, wherein the baseline further comprises historical measurements of the physical parameter at each of the at least two dry cask storage systems in the array and wherein successive measurements of at least one dry cask storage system in the array is compared to the baseline for the at least two dry cask storage systems in the array.

11. The online condition monitoring method of claim 5, further comprising observing the measurement of the physical parameter of air flow at least two inlet vents to establish at least one baseline for the parameter at each of the at least two inlet vents, monitoring successive measurements of the parameter for at least one of the at least two inlet vents, and comparing the successive measurements to the baseline for the at least one baseline at each of the at least two inlet vents.

12. The online condition monitoring method of claim 5, further comprising observing the measurement of the physical parameter of air flow at least two outlet vents to establish at least one baseline for the parameter at each of the at least two outlet vents, monitoring the successive measurements of the parameter for at least one of the at least two outlet vents, and comparing the successive measurements to the baseline for the at least one baseline at each of the at least two outlet vents.

13. A method for online condition monitoring of a dry cask storage system comprising:
observing a measurement of a physical parameter of air flow at each of the inlet vents of the dry cask storage system to establish a baseline for the parameter at each of the inlet vents;
observing the measurement of the physical parameter of air flow at each of the outlet vents of the dry cask storage system to establish a baseline for the parameter at each of the outlet vents;
monitoring successive measurements of the physical parameter for each of the inlet vents and for each of the outlet vents; and
comparing the successive measurements to the baseline.

14. The online condition monitoring method of claim 13, wherein the physical parameter is selected from the group consisting of temperature, pressure, density, mass and volumetric flow rate, nuclear radiation, impurities, humidity, salt content, acidity, chemistry, fission product gases, and combinations thereof.

15. The online condition monitoring method of claim 13, further comprising inputting the baseline and the successive measurements into a simulation model and using the baseline and the successive measurements as boundary conditions for the simulation model.

16. The online condition monitoring method of claim 15, further comprising identifying patterns from the baseline, the successive measurements, simulation model results, and conservation equations to establish a condition change signature to associate specifically to a cause of the condition change.

17. The online condition monitoring method of claim 16, wherein a difference between the baseline and the successive measurements is compared to individual uncertainties and combined uncertainties of the baseline and the individual and combined uncertainties of successive measurements.

18. The online condition monitoring method of claim 17, wherein the baseline further comprises historical measurements of the physical parameter at each inlet vent and at each outlet vent.

19. The online condition monitoring method of claim 17, wherein the baseline further comprises a difference between the measurements of the physical parameter at each inlet vent and the measurements of the physical parameter at each outlet vent over time, and the difference is integrated to establish an accumulated difference baseline of the physical parameter.

20. The online condition monitoring method of claim 17, wherein the baseline further comprises a correlation of the measurements of at least two physical parameters at each inlet vent and at each outlet vent.

21. The online condition monitoring method of claim 17, wherein the dry cask storage system is one system in an array of dry cask storage systems, and further comprises observing the measurement of the physical parameter of air flow at each inlet vent and at each outlet vent of each of the dry cask storage systems in the array to establish the baseline for the parameter at each of the dry cask storage systems in the array, monitoring the successive measurements of the parameter at each of the dry cask storage systems in the array, and comparing the successive measurements to the baseline.

22. The online condition monitoring method of claim 21, wherein the baseline further comprises historical measurements of the physical parameter at each of the dry cask storage systems in the array, and wherein successive measurements of at least one dry cask storage system in the array is compared to the baseline for each of the dry cask storage systems in the array.

23. The online condition monitoring method of claim 17, further comprising observing the measurement of the physical parameter of air flow at each inlet vent to establish at a baseline for the parameter at each inlet vent, monitoring the successive measurements of the parameter for one inlet vent, and comparing the successive measurements to the baseline for the baseline at each inlet vent.

24. The online condition monitoring method of claim 17, further comprising observing the measurement of the physical parameter of air flow at each outlet vent to establish at a baseline for the parameter at each outlet vent, monitoring the successive measurements of the parameter for one outlet vent, and comparing the successive measurements to the baseline for the baseline at each outlet vent.

25. An apparatus for online condition monitoring of a dry cask storage system comprising:
at least one sensor configured to be placed over at least one inlet vent of the dry cask storage system for monitoring at least one physical parameter of air flow;
at least one sensor configured to be placed over at least one outlet vent of the dry cask storage system for monitoring the at least one physical parameter of air flow;
hardware operatively connected for interfacing with the at least one sensor at the at least one inlet vent and with the at least one sensor at the at least one outlet vent; and
a computer operatively connected to the sensor interfacing hardware to acquire, display, and analyze physical parameter data produced by the sensor.

26. The apparatus for online condition monitoring of a dry cask storage system of claim 25, wherein the computer further displays a status of the dry cask storage system, establishes baselines for physical parameter data, establishes condition change signatures, establishes accumulation profiles, establishes physical parameter profiles, compares successive measurements to baselines, and displays condition alerts.
